(19) United States
(12) Patent Application Publication
(10) Pub. No.: US 2025/0252788 A1
(43) Pub. Date: Aug. 7, 2025

(54) METHOD AND DEVICE FOR RECOGNIZING A HANDS-OFF STATE AT A STEERING WHEEL OF A VEHICLE

(71) Applicant: Volkswagen Aktiengesellschaft, Wolfsburg (DE)

(72) Inventors: Felix Stahl, Braunschweig (DE); Jonas Kaste, Braunschweig (DE); Felix Kallmeyer, Wolfsburg (DE)

(21) Appl. No.: 19/041,676

(22) Filed: Jan. 30, 2025

(30) Foreign Application Priority Data
Feb. 1, 2024 (DE) 102024200940.7

(51) Int. Cl. G07C 5/02; G05B 13/02; G06N 3/0442

(52) U.S. Cl. CPC G07C 5/02; G05B 13/027; G06N 3/0442

(57) ABSTRACT

A method for recognizing a hands-off state at a steering wheel of a vehicle includes detecting at least one steering variable at the steering wheel, detecting, determining, and/or querying at least one piece of context information, and supplying the detected steering variable and context information as input data to a trained machine learning model. The model is configured to recognize a hands-off state based on at least the detected steering variable and context information and to output an associated piece of state information. The steering variable and context information may be processed by separate components of the model. Additionally, or alternatively, at least one component of the model that processes the steering variable may be initialized based on the context information. A device for recognizing a hands-off state at a steering wheel is also provided.

### RELATED APPLICATIONS

The present application claims priority to German Patent Application No. 10 2024 200 940.7, filed Feb. 1, 2024, the contents of which is incorporated by reference in their entirety herein.

### TECHNICAL FIELD

The present disclosure relates to a method and to a device for recognizing a hands-off state at a steering wheel of a vehicle.

### BACKGROUND

Sensors, such as capacitive steering wheels, are used in vehicles to monitor driver activity. A capacitive steering wheel detects whether the driver is touching or not touching (“hands-off”) the steering wheel using a capacitive sensor. The detected result is transmitted to various functions, such as a longitudinal and/or lateral guidance assistance system. Driver activity and attention can be inferred based on whether the driver's hands are in contact with the steering wheel. For example, if it is determined that the driver's hands have not been on the steering wheel for a predefined period during lateral guidance, a prompt may be issued to advise the driver to place their hands back on the steering wheel.

To reduce costs associated with integrating a capacitive sensor into the steering wheel, it is known to monitor driver activity using artificial neural networks that analyze torque (hand moment) detected at the steering wheel. For example, such a method is disclosed in DE 10 2019 211 016 A1. Another method is described in CN 115782892 A. A key challenge in torque-based detection methods is distinguishing steering torque exerted by the driver from other sources of measured (noisy) steering torque. Several factors contribute to noisy steering torque, including the position of the sensor, which is typically part of the steering gear or steering assistance system. Due to elasticities in the steering column and the momentum of the steering wheel, torsional vibrations can occur, making it difficult to precisely measure the moment induced by the driver. The intensity of friction within the steering system, road feedback caused by surface irregularities, the weight of the steering wheel and steering system, and vibrations introduced by assistance functions, such as haptic feedback provided when the vehicle deviates from a roadway, also affect the accuracy of hands-off detection.

Furthermore, characteristics of the measured steering torque, which are used for hands-off detection, can vary due to external influences. Changes in temperature, variations in vehicle load conditions, the presence of a trailer, differences in tire type and tire condition, long-term changes in the steering system over its service life, and roadway factors such as grade, slope, or pitch can all affect detection accuracy. Additionally, hand size and grip position influence the sensitivity of hands-off detection. Larger hands generally create greater friction compared to smaller hands. Similarly, a grip using only two or three fingers around the steering wheel differs from a grip in which the entire hand is wrapped around it. The moisture level of the driver's palms can also have an impact. If additional information regarding these factors is available, for instance, through a cabin camera or a weight sensor in the seat to estimate hand size, such data can be incorporated into the detection function.

To ensure robust detection of a hands-off state, it is necessary to account for all the aforementioned influences and scenarios in the training data. However, achieving comprehensive coverage is challenging in practice, as the input data spans a highly complex and multidimensional space.

### SUMMARY

The present disclosure provides a method and a device for recognizing a hands-off state at a steering wheel of a vehicle.

Certain aspects of the present disclosure are set forth in the independent claims, while additional aspects are described in the dependent claims, the detailed description, and the accompanying drawings.

In some examples, a method is disclosed for recognizing a hands-off state at a steering wheel of a vehicle. The method includes detecting at least one steering variable at the steering wheel, detecting, determining, and/or querying at least one piece of context information, and supplying the detected steering variable and context information as input data to a trained machine learning model. The machine learning model is trained to recognize a hands-off state based on at least the detected steering variable and context information and to output an associated piece of state information as output data. In some examples, the at least one steering variable and the at least one piece of context information are processed by separate components of the trained machine learning model. Additionally, or alternatively, at least one component of the trained machine learning model that processes the steering variable is initialized based on the at least one piece of context information.

In some examples, a device is disclosed for recognizing a hands-off state at a steering wheel of a vehicle. The device includes at least one steering variable sensor configured to detect at least one steering variable at the steering wheel and a data processing unit configured to receive the detected steering variable and at least one detected, determined, and/or queried piece of context information. The data processing unit is further configured to provide a trained machine learning model and to supply the detected steering variable and the at least one piece of context information to the trained machine learning model as input data. The machine learning model is trained to recognize a hands-off state based on at least the detected steering variable and the at least one piece of context information and to output an associated piece of state information as output data. In some examples, the at least one steering variable and the at least one piece of context information are processed by separate components of the trained machine learning model. Additionally, or alternatively, at least one component of the trained machine learning model that processes the steering variable is initialized based on the at least one piece of context information.

Further features regarding the configuration of the device are apparent from the description of the method. The advantages of the device correspond to those of the method described herein.

Additionally, a steering system is provided that includes a device configured in accordance with one or more of the described examples.

Furthermore, a vehicle is provided that includes a steering system configured in accordance with one or more of the described examples and/or a device configured in accordance with one or more of the described examples.

### BRIEF DESCRIPTION OF THE DRAWINGS

Aspects of the present disclosure will be described in greater detail hereafter with reference to preferred exemplary embodiments and the accompanying figures. In the drawings:

FIG. 1 is a schematic representation illustrating embodiments of a device for recognizing a hands-off state at a steering wheel, according to some aspects of the present disclosure;

FIG. 2 is a schematic representation illustrating embodiments of the method and the device, according to some aspects of the present disclosure;

FIG. 3 is a schematic representation illustrating embodiments of the method and the device, according to some aspects of the present disclosure; and

FIG. 4 is a schematic representation illustrating one embodiment of the method and the device, according to some aspects of the present disclosure.

### DETAILED DESCRIPTION

The method and device disclosed herein enable improved consideration of context information when recognizing a hands-off state while reducing computational and memory requirements. One fundamental aspect involves processing the detected at least one steering variable and the at least one piece of context information using separate components of the trained machine learning model, at least in part. By structuring the machine learning model in this manner, its complexity can be reduced since not all nodes in the input layer must process all input data. Another aspect, which may be used as an alternative or in addition, involves initializing at least one component of the trained machine learning model responsible for processing the steering variable based on the at least one piece of context information. In other words, this component is preconditioned according to the present context described by the at least one piece of context information, thereby improving accuracy in recognizing the hands-off state.

A steering variable refers to a variable that represents or describes the current state of the steering wheel. In particular, a steering variable may be a torque value detected using a torque sensor at the steering wheel. However, a steering variable may also be another variable directly or indirectly detected at the steering wheel. For example, a current measurement at an electric machine associated with the steering wheel may be used as a steering variable. The recognition of the hands-off state may rely solely on the steering variable detected at the steering wheel, particularly on a detected torque. However, it is also possible for the trained machine learning model to be supplied with additional steering variables detected at the steering wheel, such as a steering wheel angle or a steering wheel angular velocity, and to recognize the hands-off state based on these additional variables. Furthermore, variables not detected at the steering wheel, such as vehicle speed, lateral acceleration, yaw rate, wheel rotation counts, damper information, or other driving dynamics variables, may be considered as context information. However, no capacitive sensor is required at the steering wheel.

The recognition of a hands-on state may also be performed as part of the hands-off state recognition process. A hands-off state generally refers to a condition in which the driver is not touching the steering wheel, meaning that none of the driver's fingers are in contact with it. The recognition of the hands-off state may include the generation of a hands-off state signal. This signal may represent a hands-off probability or may be encoded as a binary signal with distinct states, such as “hands-off recognized” and “hands-off not recognized.” A hands-on state refers to a condition in which the driver is touching the steering wheel. The hands-on or hands-off state may be provided, for example, as a hands-on/hands-off state signal, which may have at least two states, such as “hands-on recognized” and “hands-off recognized.”

Context information refers to characteristics of the situation in which the hands-off state recognition occurs or in which one or more values of the at least one steering variable are detected. Examples of characteristics that define a context include outside temperature, inside temperature, steering wheel vibrations, vehicle load, the presence of a trailer, the presence of snow chains, road surface conditions such as cobblestones or potholes, maximum steering interventions such as steering-induced vibrations, speed bumps, and driver-specific characteristics such as identity, gender, age, weight, and hand size. The specific pieces of context information used may vary depending on the implementation, and not all listed variables are required in every example.

The machine learning model may include one or more neural networks, which may have multiple internal layers. In some examples, the machine learning model comprises an artificial recurrent neural network configured to process input data Xₜ at any point in time and outputs a hands-off probability yₜ in [0,1]: yₜ=p(xₜ|x_{0:t-1}). The recurrent neural network includes a memory component hₜ, which stores information from previous time steps and utilizes this information when generating an output at the present time step.

The output data of the trained machine learning model may undergo further processing, such as filtering, before being utilized by vehicle functions, such as a lateral guidance assistance system. The processed data may be used to generate a binary hands-off signal based on a comparison between the hands-off probability and a predefined threshold value, with possible states including “hands-off recognized” and “hands-off not recognized.”

During a training phase, the machine learning model is trained across various contexts, meaning that the at least one piece of context information is considered within the training data. The training data includes pairs where each instance of steering variable data, particularly torque data, is associated with a hands-off state serving as ground truth. The steering variable data, particularly torque data, is typically recorded as time series data detected at the steering wheel. The training data may be collected using test drives and/or simulators. In general, the generation of training data may be performed using a method such as that described in DE 10 2019 211 016 A1. The training itself may be carried out using supervised learning techniques.

Components of the device, particularly the data processing unit, may be implemented as a combination of hardware and software, such as program code executed on a microcontroller or microprocessor. Alternatively, individual or combined components may be implemented as an application-specific integrated circuit (ASIC) and/or a field-programmable gate array (FPGA). The data processing unit may include at least one computing unit and at least one memory.

In one example, the at least one steering variable is processed by a recurrent neural network within the trained machine learning model, while the at least one piece of context information is processed by a non-recurrent neural network. The respective outputs from these networks are then combined in at least one layer of the trained machine learning model to generate the final output data. This configuration enables a reduction in computational and memory requirements when processing the at least one piece of context information, as a non-recurrent neural network requires fewer computational resources. Despite the lower computational requirements, the at least one piece of context information remains an integral factor in the recognition of the hands-off state. In some examples, the outputs from the recurrent and non-recurrent neural networks are combined in a dense layer or fully connected layer to generate the output data. During the training process, both neural networks are trained simultaneously. The non-recurrent neural network may be configured to have a smaller structure compared to the recurrent neural network.

In some examples, the initialization of at least one part of the trained machine learning model that processes the detected at least one steering variable is performed based on the at least one piece of context information. Specifically, the starting parameters of this part are determined using a mapping rule, and the part is initialized accordingly. The mapping rule is configured such that the at least one piece of context information is mapped to corresponding values of the starting parameters. In this manner, the starting parameters can be derived dynamically based on the present context.

In some examples, the mapping rule is implemented using a trained neural network, allowing the starting parameters to be estimated and provided for various contexts and pieces of context information. The trained neural network may be designed as a dense layer network or a fully connected network and is trained during the training phase of the overall machine learning model. However, during an inference phase, the neural network is executed only once to apply the mapping rule and provide the starting parameters based on the given context or at least one piece of context information. After initialization, the neural network is no longer used for the mapping rule, thereby optimizing computational efficiency.

In some examples, the part of the trained machine learning model that processes the detected at least one steering variable is implemented as a recurrent neural network, where the starting parameters include at least one memory element of the recurrent neural network. By initializing the memory element with suitable values rather than the conventional approach of setting it to zeros or random values, the functional accuracy of the model can be improved from the outset.

In some examples, a portion of the trained machine learning model responsible for providing the mapping rule is deactivated after initialization. By deactivating this component when the mapping rule is no longer required, computing and memory resources can be conserved.

In some examples, the initialization process is repeated if the at least one piece of context information changes. This allows the model to adapt to changes in the context, enabling the part of the trained machine learning model that processes the at least one steering variable to be re-initialized based on the updated context or the updated at least one piece of context information. A change in context or the at least one piece of context information may need to exceed a predefined threshold value for re-initialization to occur. The extent of the change can be quantified using a measurable parameter, the value of which is compared to the predefined threshold value. If the part of the trained machine learning model responsible for providing the mapping rule was previously deactivated, it is reactivated upon detecting a change in the at least one piece of context information and remains active only for the duration of the renewed initialization. After the updated initialization, this part is deactivated again, and the process repeats as necessary.

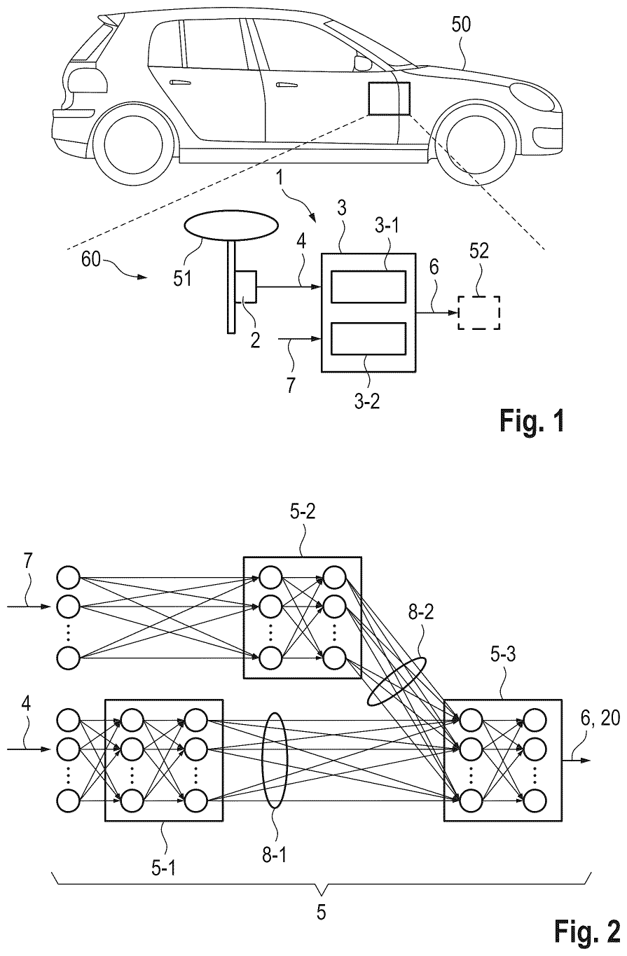

FIG. 1 shows a schematic representation of an embodiment of the device 1 for recognizing a hands-off state 6 at a steering wheel 51. The device 1 is arranged in a vehicle 50, where it is part of a steering system 60. The method described in the present disclosure is further clarified based on the operation of the device 1.

The device 1 comprises a steering variable sensor 2 and a data processing unit 3. The steering variable sensor 2 is configured to detect a steering variable 4 at the steering wheel 51 of the vehicle 50. In some examples, the steering variable sensor 2 is a torque sensor, and the steering variable 4 corresponds to a torque measurement. Alternatively or additionally, further steering variable sensors may be provided to detect additional steering variables.

The data processing unit 3 includes a computing unit 3-1 and a memory 3-2. The computing unit 3-1 is configured to execute computations necessary for implementing the method, while the memory 3-2 stores relevant data accessible by the computing unit 3-1.

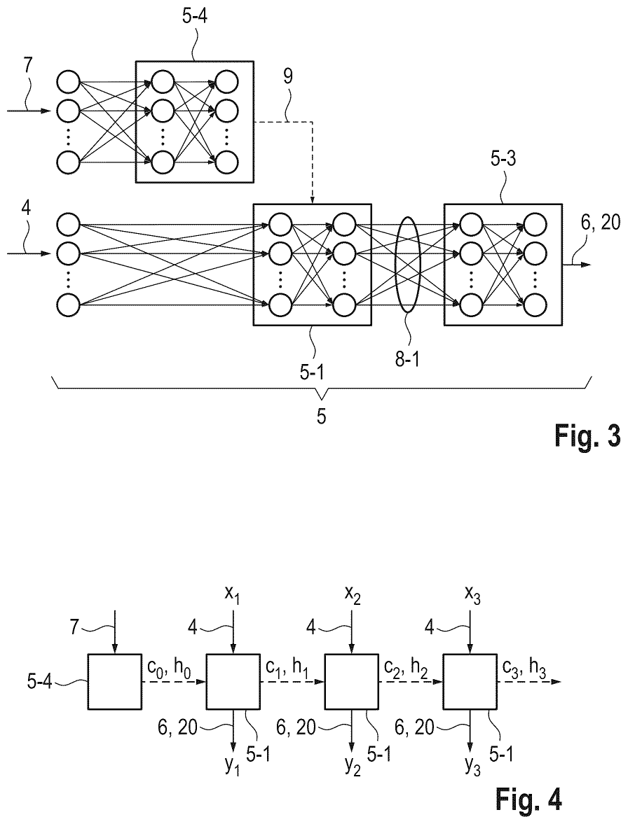

The data processing unit 3 is further configured to obtain the detected at least one steering variable 4 and at least one detected, determined, and/or queried piece of context information 7, to provide a trained machine learning model 5 (see also FIGS. 2 and 3), and to supply the detected at least one steering variable 4 and the at least one piece of context information 7 to the trained machine learning model 5 as input data.

The trained machine learning model 5 is trained to recognize a hands-off state 6, proceeding from at least the detected at least one steering variable 4 and the at least one piece of context information 7, and to output an associated state signal or an associated piece of state information as output data 20.

In some examples, referred to as variant i), the at least one steering variable 4 and the at least one piece of context information 7 are processed by separate components of the trained machine learning model 5. In addition or as an alternative, in variant ii), at least one component of the trained machine learning model 5 that processes the at least one steering variable 4 is initialized based on the at least one piece of context information 7.

The recognized hands-off state 6 is supplied as a state signal or as state information to a control unit 52 of the vehicle 50 for further processing. The control unit 52 may, for example, be a transverse guidance assistance system or another driver assistance system. The state signal or state information may include a hands-off probability or a binary state value with two states: “Hands-off recognized” and “Hands-off not recognized.”

FIG. 2 illustrates variant i) in a schematic representation. The trained machine learning model 5 comprises a first part 5-1, which is configured as a neural network and processes the detected at least one steering variable 4. The trained machine learning model 5 further comprises a second part 5-2, which is configured as a neural network and processes the at least one piece of context information 7. Additionally, the trained machine learning model 5 includes a third part 5-3, which may also be implemented as a neural network having at least one layer. The outputs 8-1 and 8-2 from the first part 5-1 and the second part 5-2, respectively, are combined in the third part 5-3, which then provides the final result for the hands-off state 6 as output data 20.

In some examples, the trained machine learning model 5 processes the at least one steering variable 4 using a recurrent neural network, while the at least one piece of context information 7 is processed using a non-recurrent neural network. The respective outputs are then combined in at least one layer of the trained machine learning model 5 to generate the output data 20. In particular, the first part 5-1 comprises the recurrent neural network, the second part 5-2 comprises the non-recurrent neural network, and the third part 5-3 comprises at least one layer for combining the outputs. The non-recurrent neural network is designed to be smaller in structure compared to the recurrent neural network, thereby optimizing computational efficiency.

FIG. 3 illustrates one embodiment of the method and device with respect to variant ii). In this embodiment, starting parameters 9 for at least the first part 5-1 of the trained machine learning model 5, which processes the detected at least one steering variable 4, are determined based on the at least one piece of context information 7. The starting parameters 9 are derived using a mapping rule 5-4, and the first part 5-1 is initialized accordingly. This initialization occurs, in particular, only for a single time step, during which all parameters of the first part 5-1 are set based on the starting parameters 9.

After the initialization, the mapping rule 5-4 is not further used. In some examples, a portion of the trained machine learning model 5 responsible for providing the mapping rule 5-4 is deactivated after the initialization to optimize computational efficiency.

The mapping rule 5-4 may be implemented using a trained neural network, which may include, for example, a dense layer or a fully connected layer. In some implementations, the mapping rule 5-4 is configured as an affine transformation. Specifically, the trained neural network forming the mapping rule 5-4 estimates the starting parameters 9 based on the at least one piece of context information 7, which is supplied as input data. The specific vector length for the transformation depends on the architecture of the recurrent neural network and is chosen based on the requirements of the trained model.

The affine transformation is particularly useful for converting categorical context information (e.g., trailer presence, loading state, or tire type) into a numerical vector representation suitable for initialization. The specific vector length is determined based on the architecture of the recurrent neural network to ensure proper initialization. For instance, in an LSTM network with 16 units, the affine transformation may generate a vector of length 16. The affine transformation can be implemented as a dense layer with three inputs and 16 outputs. The mapping rule 5-4, implemented as this additional dense layer, forms part of the trained machine learning model 5 but is used only prior to the first time step (t=0) during initialization. The at least one piece of context information 7 is supplied as input data to the affine transformation, but its output is not used as input data for the first part 5-1. Instead, the output initializes the internal state of the first part 5-1 before continuous inference begins at subsequent time steps (t=1, 2, . . . T), during which steering data such as steering torque and steering wheel angle are processed. This ensures that the initial state is properly conditioned based on the given context before normal operation begins.

The mapping rule 5-4, and in particular the dense layer, is also trained during the training phase of the trained machine learning model 5. In an exemplary Many-to-One training process, a data point consists of continuous data (a matrix of size n×T), a ground truth scalar at time step t=T, and the at least one piece of context information 7 (a vector of length m). The trained machine learning model 5, including parts 5-1, 5-3, and 5-4, operates as described above. An error at time step t=T is computed by comparing the output with the ground truth, and this error is back-propagated through the initialization at t=0 for each time step, allowing the dense layer to learn the mapping rule 5-4.

In some implementations, the first part 5-1 of the trained machine learning model 5, which processes at least the detected at least one steering variable 4, is designed as a recurrent neural network, such as a long short-term memory (LSTM) network. The starting parameters 9 include at least one memory component, typically denoted as hₜ, of the recurrent neural network. Additionally, the starting parameters 9 may include further parameters specific to the recurrent neural network. In particular, it may be provided that the starting parameters 9 include the parameters c₀ (cell state) and h₀ (memory state) of the LSTM network.

In some implementations, the initialization process in variant ii) is repeated when the at least one piece of context information 7 changes.

FIG. 4 schematically illustrates the sequence of variant ii) for explanatory purposes. The figure shows the initialization at time step t=0, as well as three subsequent time steps at t=1, 2, 3. At t=0, the starting parameters 9 of the first part 5-1 of the trained machine learning model 5 are estimated using the mapping rule 5-4, and in particular, using the trained neural network. In the illustrated example, the starting parameters 9 include the values c₀ and h₀ at time step t=0. In each subsequent time step, values Xₜ corresponding to the at least one steering variable 4 are supplied to the first part 5-1, which then determines the hands-off state 6 and generates output values yₜ. The parameters from the prior time step are taken into account for each subsequent time step, with the illustrated example showing parameters ct and hₜ being updated accordingly.

In some implementations, variants i) and ii) may also be combined, allowing both processing methods to be utilized together for improved recognition of the hands-off state 6.

### LIST OF REFERENCE SIGNS

1 device
2 steering variable sensor
3 data processing unit
3-1 computing unit
3-2 memory
4 steering variable
5 trained machine learning model
5-1 first part
5-2 second part
5-3 third part (min. one layer)
5-4 mapping rule
6 hands-off state
7 context information
8-1 output
8-2 output
9 starting parameter
20 output data
50 vehicle
51 steering wheel
52 control unit
60 steering system
ct cell state
hₜ memory
t point in time

1. A method for recognizing a hands-off state at a steering wheel of a vehicle, comprising:
detecting at least one steering variable at the steering wheel;
detecting at least one piece of context information;
supplying the detected at least one steering variable and the detected at least one piece of context information as input data to a trained machine learning model;
processing, by the trained machine learning model, the detected at least one steering variable and the detected at least one piece of context information to recognize a hands-off state based on at least the detected at least one steering variable and the detected at least one piece of context information and to output an associated piece of state information as output data; and
performing at least one of (i) processing the detected at least one steering variable and the detected at least one piece of context information using separate components of the trained machine learning model, and (ii) initializing at least one component of the trained machine learning model that processes the detected at least one steering variable based on the detected at least one piece of context information.

2. The method of claim 1, further comprising:
processing the detected at least one steering variable using a recurrent neural network of the trained machine learning model;
processing the detected at least one piece of context information using a non-recurrent neural network of the trained machine learning model; and
combining respective outputs of the recurrent and non-recurrent neural networks in at least one layer of the trained machine learning model to provide the output data.

3. The method of claim 1, further comprising:
determining starting parameters for at least one component of the trained machine learning model that processes the detected at least one steering variable based on a mapping rule; and
initializing the at least one component using the determined starting parameters.

4. The method of claim 3, herein the mapping rule is provided by a trained neural network.

5. The method of claim 3, wherein initializing the at least one component comprises initializing a recurrent neural network within the trained machine learning model, wherein the starting parameters include at least one memory of the recurrent neural network.

6. The method of claim 3, further comprising deactivating a component of the trained machine learning model that provides the mapping rule after initialization.

7. The method of claim 1, further comprising repeating the initialization of at least one component of the trained machine learning model that processes the at least one steering variable in response to detecting a change in the at least one piece of context information.

8. A device for recognizing a hands-off state at a steering wheel of a vehicle, comprising:
at least one steering variable sensor configured to detect at least one steering variable at the steering wheel; and
a data processing unit configured to:
obtain the detected at least one steering variable and at least one detected piece of context information;
provide a trained machine learning model;
supply the detected at least one steering variable and the detected at least one piece of context information to the trained machine learning model as input data;
process, by the trained machine learning model, the detected at least one steering variable and the detected at least one piece of context information to recognize a hands-off state based on at least the detected at least one steering variable and the detected at least one piece of context information and to output an associated piece of state information as output data; and
perform at least one of (i) processing the detected at least one steering variable and the detected at least one piece of context information using separate components of the trained machine learning model, and (ii) initializing at least one component of the trained machine learning model that processes the detected at least one steering variable based on the detected at least one piece of context information.

9. The device of claim 8, wherein the data processing unit is further configured to:
process the detected at least one steering variable using a recurrent neural network of the trained machine learning model;
process the detected at least one piece of context information using a non-recurrent neural network of the trained machine learning model; and
combine respective outputs of the recurrent and non-recurrent neural networks in at least one layer of the trained machine learning model to provide the output data.

10. The device of claim 8, wherein the data processing unit is further configured to:
determine starting parameters for at least one component of the trained machine learning model that processes the detected at least one steering variable based on a mapping rule; and
initialize the at least one component using the determined starting parameters.

11. The device of claim 10, wherein the mapping rule is provided by a trained neural network.

12. The device of claim 10, wherein the at least one component of the trained machine learning model comprises a recurrent neural network, and the starting parameters include at least one memory of the recurrent neural network.

13. The device of claim 10, wherein the data processing unit is further configured to deactivate a component of the trained machine learning model that provides the mapping rule after initialization.

14. The device of claim 8, wherein the data processing unit is further configured to repeat the initialization of at least one component of the trained machine learning model that processes the detected at least one steering variable in response to detecting a change in the at least one piece of context information.

15. A steering system, comprising:
a device configured to recognize a hands-off state at a steering wheel of a vehicle, the device comprising:
at least one steering variable sensor configured to detect at least one steering variable at the steering wheel; and
a data processing unit configured to:
obtain the detected at least one steering variable and at least one detected piece of context information;
provide a trained machine learning model;
supply the detected at least one steering variable and the detected at least one piece of context information to the trained machine learning model as input data;
process, by the trained machine learning model, the detected at least one steering variable and the detected at least one piece of context information to recognize a hands-off state based on at least the detected at least one steering variable and the detected at least one piece of context information and to output an associated piece of state information as output data; and
perform at least one of (i) processing the detected at least one steering variable and the detected at least one piece of context information using separate components of the trained machine learning model, and (ii) initializing at least one component of the trained machine learning model that processes the detected at least one steering variable based on the detected at least one piece of context information.

16. The steering system of claim 15, wherein the data processing unit is further configured to:
process the detected at least one steering variable using a recurrent neural network of the trained machine learning model;
process the detected at least one piece of context information using a non-recurrent neural network of the trained machine learning model; and
combine respective outputs of the recurrent and non-recurrent neural networks in at least one layer of the trained machine learning model to provide the output data.

17. The steering system of claim 15, wherein the data processing unit is further configured to:
determine starting parameters for at least one component of the trained machine learning model that processes the detected at least one steering variable based on a mapping rule; and
initialize the at least one component using the determined starting parameters.

18. The steering system of claim 17, wherein the mapping rule is provided by a trained neural network.

19. The steering system of claim 17, wherein the at least one component of the trained machine learning model comprises a recurrent neural network, and the starting parameters include at least one memory of the recurrent neural network.

20. The steering system of claim 17, wherein the data processing unit is further configured to deactivate a component of the trained machine learning model that provides the mapping rule after initialization.
